(19) United States
(12) Patent Application Publication
(10) Pub. No.: US 2023/0332867 A1
(43) Pub. Date: Oct. 19, 2023

(54) ANTI-BALLISTIC PLATE ASSEMBLY

(71) Applicant: NFM AS, Ski (NO)

(72) Inventor: Jan Örjan AHLBERG, Solna (SE)

(73) Assignee: NFM AS, Ski (NO)

(21) Appl. No.: 17/784,902

(22) PCT Filed: Jan. 13, 2021
(86) PCT No.: PCT/EP2021/050501

§ 371 Date: Jun. 13, 2022

(30) Foreign Application Priority Data
Jan. 15, 2020 (NO) 20200047

(51) Int. Cl. F41H 1/02

(52) U.S. Cl. CPC F41H 1/02

(57) ABSTRACT

Anti-ballistic plate assembly (10), having an anti-ballistic front plate (1) with an inner face (1b) and an outer face (1c), anti-ballistic back plate (2) with inner face (2b) and outer face (2c). Two carrying straps (5) extends on respective side of the person’s neck are attached to the front plate (1) and/or the back plate (2), respectively, at respective attachment areas (7a, 7b) located at the inner face (1b, 2b). The anti-ballistic front plate and/or back plate have an upper and inner edge portion (1d, 2d). The attachment area (7a, 7b) of the front plate (1) and/or back plate, respectively, is arranged a respectively first and/or second vertical distance (D1, D2) below the upper and inner edge portion (1d, 2d).

### TECHNICAL FIELD

The present invention relates to an anti-ballistic plate assembly configured to be worn by a person to provide anti-ballistic protection of a person’s chest portion.

### BACKGROUND ART

Damage caused by ballistic projectiles to structures within the thorax and abdomen remain the leading cause of death on the battlefield. Ballistic protection in the form of rigid composite plates constructed from a ceramic strike face with a backing of high tenacity fibers is currently the most effective form of protection for the essential anatomical structures, i.e. the heart, the great vessels, the liver and the spleen.

Ballistic protection plates can be constructed in order to function as stand alone (SA), i.e. without additional protection elements in order to obtain the required performance, or in conjunction with (ICW), i.e. in combination with a second protection element providing additional reduction of energy during impact. This second element is generally constructed from a softer composition of high tenacity fibers that covers the desirable anatomical structures, such as lungs, kidneys, intestines and spinal cord and may also be used to protect other parts of the body such as the extremities.

Due to the increasing amount of equipment and consequently weight a soldier is required to carry, the physical and cognitive performance of the soldier is reduced. In addition to the weight, the wearing of protection plates covering the torso leads to reduced thermoregulation. This has led to a demand for lighter protection equipment with less surface covered, essentially leaving only the essential anatomical structures covered by SA ballistic protection plates. These plates are generally carried in a textile cover often referred to as a plate carrier (PC).

The anti-ballistic plates are generally produced in a shape and curvature which admits a proper fit for a generic male chest front. Due to their shape and rigidity they are however ill-fitting for the back.

Existing plate carriers, or anti-ballistic plate assemblies, do not take into account the incompatibility of the plate shape for the back-body shape. Attaching the plate carrier strap (shoulder strap) on the outer face of the plate or at the upper, outer edge portion of the plate, results in a pull of the upper part of the plate towards the body. This creates pressure points at the shoulder blade and the upper part of the chest. It also creates increased pressure at the shoulders due to the reduced contact surface between the carrier straps and the body / shoulders.

Publication US20120132065 discloses a plate carrier carrying a ballistic plate.

### SUMMARY OF INVENTION

According to the present invention, there is provided an anti-ballistic plate assembly configured to be worn by a person, the assembly comprising an anti-ballistic front plate configured to protect the front of a chest of the person and having an inner face and an outer face, and/or an anti-ballistic back plate configured to protect the back of a person and having an inner face and an outer face. The assembly further comprises two carrying straps extending over a shoulder of the person, on respective side of the person’s neck. The carrying straps are attached to the front plate or the back plate, respectively, or to the front plate and the to the back plate, respectively, at respective attachment areas. The attachment areas are located at the inner face. The anti-ballistic front plate or the anti-ballistic back plate, or both the anti-ballistic front plate and the anti-ballistic back plate, have an upper and inner edge portion. According to the invention, the attachment area of the front plate or back plate, or the attachment area of both the front plate and the back plate, respectively, is arranged a respectively first and/or second vertical distance below the upper and inner edge portion.

It shall be appreciated that the carrying straps may in some embodiments be attached directly to the anti-ballistic plates. However, as is common in the art, the carrying straps can connect to a plate carrier (PC) as referred to above, or other type of plate-carrying means.

While common worn anti-ballistic plates have a substantially straight upper and inner edge portion, other designs may be possible. For instance, the upper and inner edge portion may have a curved shape. The said vertical distance would in such embodiments be measured between the uppermost vertical position along such a curved edge portion and the uppermost location of the attachment area.

In some embodiments of the present invention, the assembly comprises an anti-ballistic front plate and an anti-ballistic back plate, wherein the first vertical distance is smaller than the second vertical distance. This applies in particular to embodiments wherein the front plate and the back plate are of identical shape. In such embodiment, having the said difference between the first and second vertical distances contributes in adapting the plates to the different body shape at the front chest and the back of a carrying person.

In preferred embodiments the first vertical distance is between 20 and 50 mm, more preferably between 25 and 35 mm, or between 25 and 30 mm.

Furthermore, advantageously the second vertical distance can be between 30 and 80 mm, more preferably between 40 and 70 mm, or between 55 and 60 mm.

The front plate and/or the back plate can have a width between 200 and 300 mm, and a height between 250 and 350 mm.

### DETAILED DESCRIPTION OF THE INVENTION

While various features of the invention have been discussed in general terms above, a non-limiting example of embodiment will be presented in the following with reference to the drawings, in which

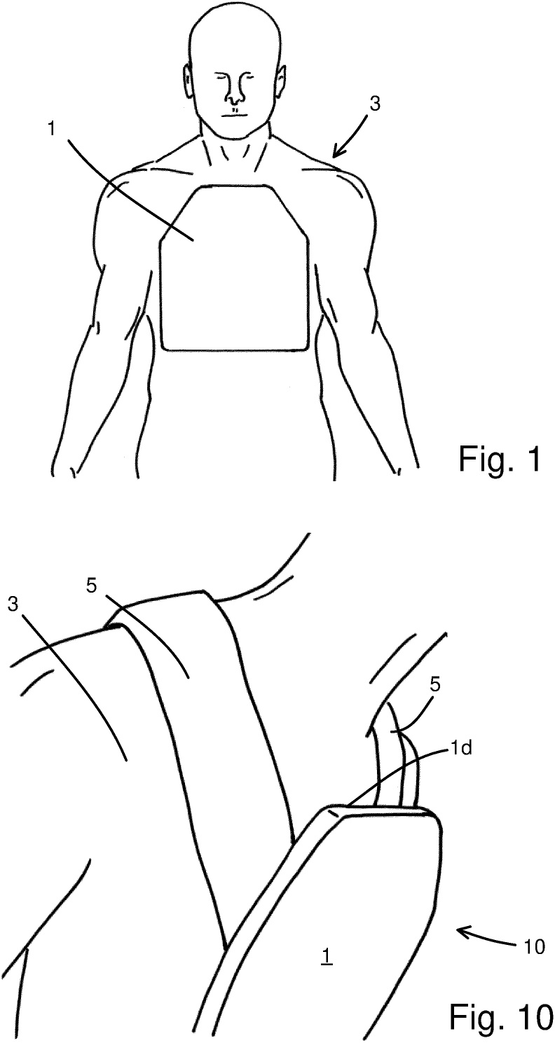

FIG. 1 is a principle front view of a person and an anti-ballistic plate protecting a portion of the person’s chest;

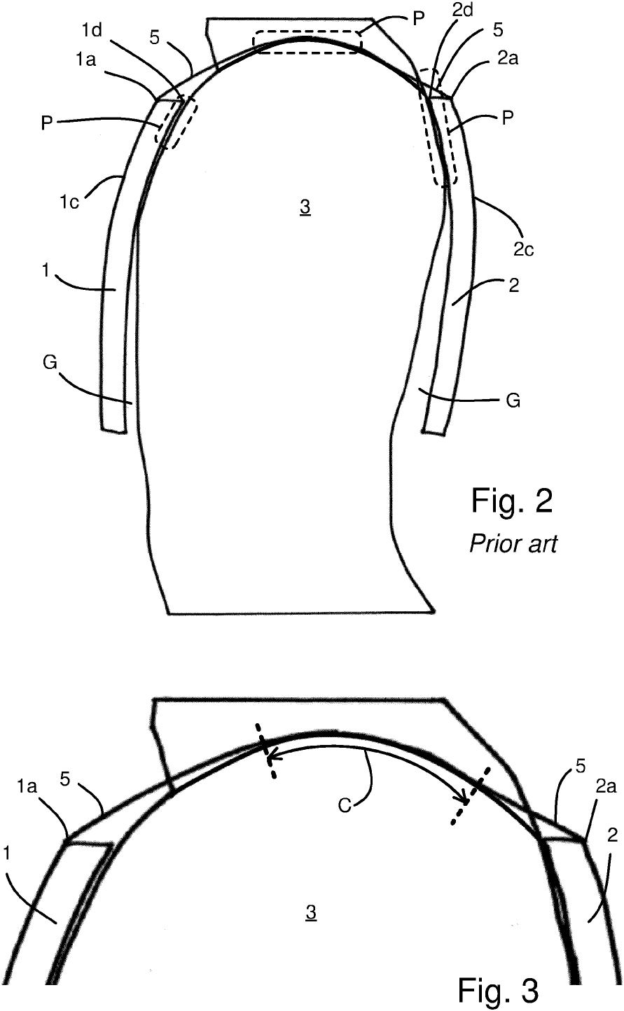

FIG. 2 is a schematic side view of an anti-ballistic front plate and a back plate carried by a person using an anti-ballistic plate assembly according to prior art;

FIG. 3 is an enlarged portion of FIG. 2, illustrating some disadvantages of the prior art solutions;

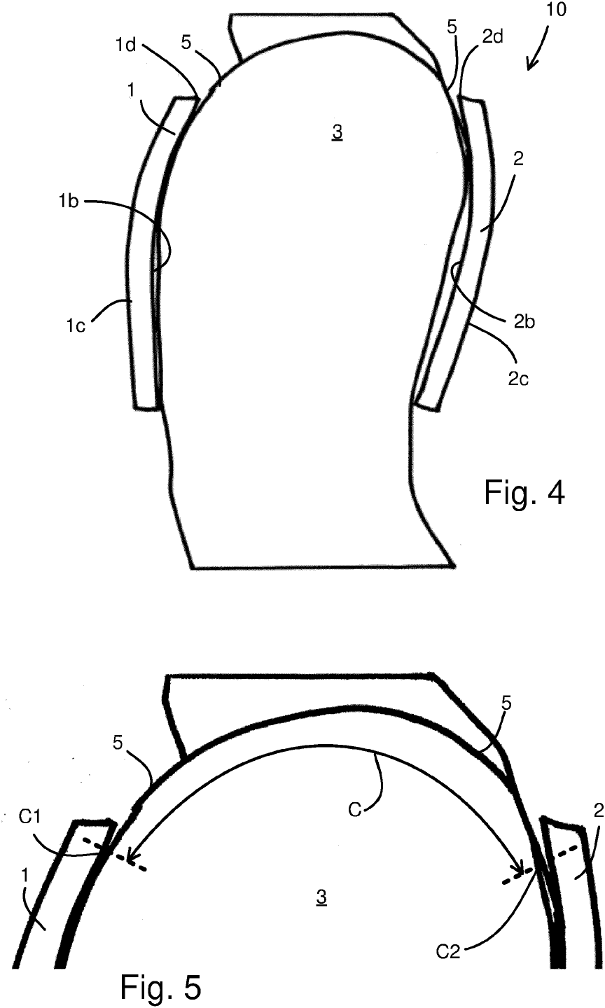

FIG. 4 is a side view corresponding to FIG. 2, however of an anti-ballistic plate assembly according to the invention;

FIG. 5 is an enlarged portion of FIG. 4, illustrating advantages of the present invention;

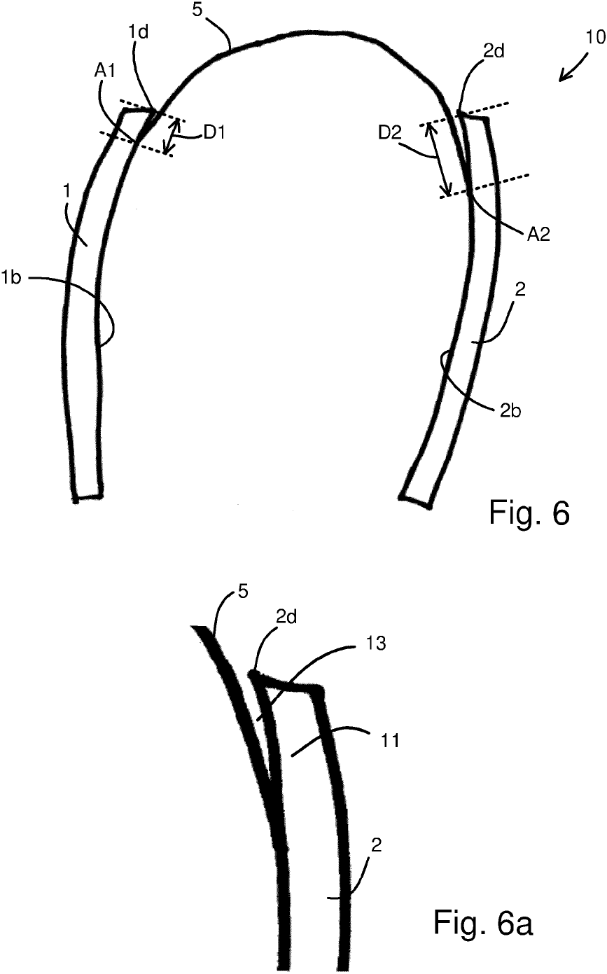

FIG. 6 is a schematic side view of the assembly according to the invention;

FIG. 6a is an enlarged portion of FIG. 6;

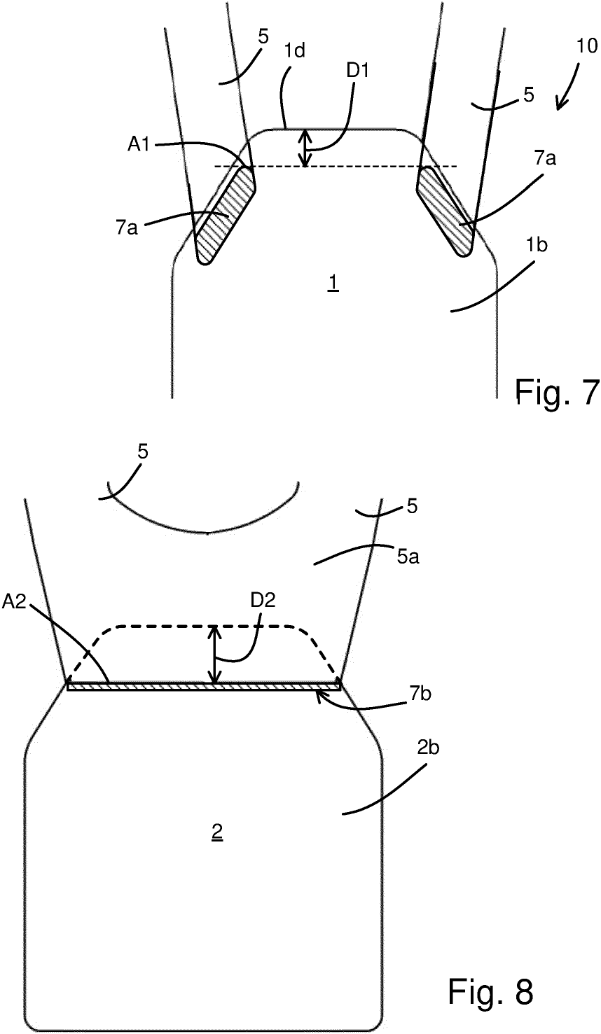

FIG. 7 is a schematic back view of an anti-ballistic front plate carried by two carrying straps, illustrating two attachment areas where the carrying straps are connected to the front plate;

FIG. 8 is a schematic back view of an anti-ballistic back plate carried by two carrying straps;

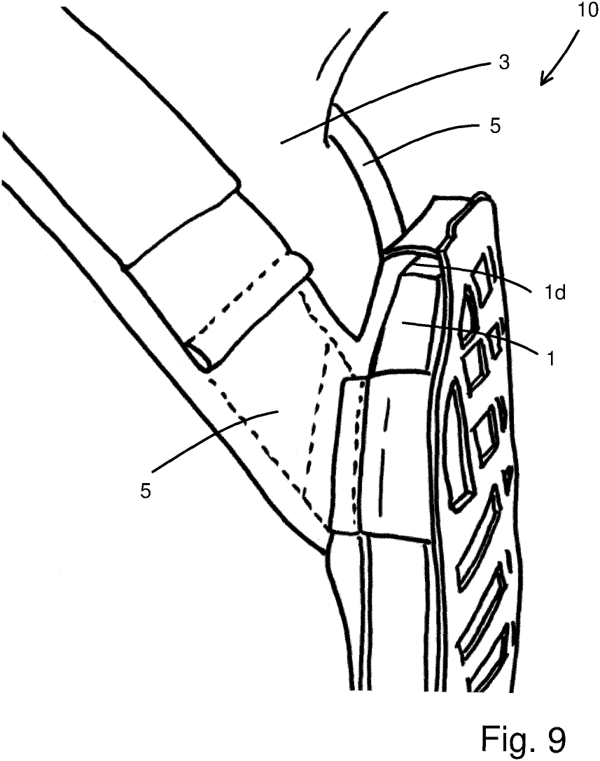

FIG. 9 is a perspective view of a portion of an anti-ballistic plate assembly according to the invention, when mounted on a person; and

FIG. 10 is a perspective principle view showing a front plate and in front of the chest of a carrying person.

FIG. 1 depicts an anti-ballistic plate 1 arranged in front of the thorax or chest portion 3 of a person. The anti-ballistic plate 1 or protection plate is typically made of a stiff composite material and is configured to protect the person from projectiles such as a bullet or high speed fragments.

Typically, the anti-ballistic plate 1 is enclosed in a fabric or other type of sheet and is worn by the person by means of a strap arrangement, which is not shown in FIG. 1.

FIG. 2 shows a schematic side view of a chest portion 3 of a person wearing an anti-ballistic plate assembly 10 according to prior art. The anti-ballistic plate assembly comprises an anti-ballistic front plate 1 arranged at the front chest portion and an anti-ballistic back plate 2 at the back portion. Extending between the two plates 1, 2 is a carrying strap 5. As shown in FIG. 2, the carrying strap 5 extends from an upper and outer edge portion 1a of the front plate 1 and the upper and outer edge portion 2a of the back plate 2.

FIG. 3 depicts the upper, enlarged portion of FIG. 2. As indicated with the curved arrow C, the contact length of the carrying strap 5 against the shoulder of the person 3, is relatively short.

In FIG. 2 three pressure points P are indicated with dashed lines. In the pressure points P, the person wearing the anti-ballistic assembly may experience uncomfortable pressure against the body. As shown with FIG. 3, one of these pressure points P is at the shoulder, where only a small surface of the shoulder is used to carry the plates 1, 2. Furthermore, since the carrying strap 5 is attached on the outer faces 1c, 2c of the plates 1, 2, an increased pressure against the body may result at the upper, inner portions of the plates, as illustrated with the remaining two pressure points P. The pressure against the body 3 at these two pressure points may further be increased, because when attaching the carrying straps 5 to the outer faces 1c, 2c of the plates 1, 2, a gap G will tend to appear between the lower part of the plate 1, 2 and the body. FIG. 2 illustrates such gaps G. To compensate for this effect (the gap G), it is common to construct the plate carrier in such a way to reduce these gaps G. This will result in even further pressure on the pressure points between the plates 1, 2 and the body.

Reference is now made to FIG. 4, which depicts an embodiment according to the present invention. A person 3 is wearing an anti-ballistic plate assembly 10, with a front plate 1, a back plate 2, and a carrying strap 5. The front plate 1 has an inner face 1b and an outer face 1c. Correspondingly, the back plate 2 has an inner face 2b and an outer face 2c.

Contrary to the embodiment belonging to prior art and shown in FIG. 2, in the embodiment shown in FIG. 4 the carrying strap 5 is attached on the inner faces 1b, 2b of the front plate 1 and back plate 2, respectively. By attaching the carrying strap 5 in this position, the carrying strap 5 will follow the body (mainly the shoulder) of the person 3 along a greater distance. This is indicated in FIG. 5 with the curved arrow C.

Advantageously, the portion of the carrying strap 5 that is attached to the front plate 1 extends from the chest, about just below the collar bones, and upwards towards the shoulder. Furthermore, the portion of the carrying strap 5 that is attached to the back plate 2 extends from about the mid height of the scapula, and upwards towards the shoulder.

In FIG. 5, the curved arrow C extends between a front contact position C1 and a rear contact position C2. The contact positions C1, C2 are the positions where the contact between the carrying strap 5 and the body of the carrying person 3 starts. As shown in FIG. 4, the carrying strap 5 is in contact with the person substantially along the entire extension between the front and rear contact positions C1, C2.

As appears from FIG. 4, by attaching the carrying strap 5 at the inner face 1b, 2b of the plate 1, 2, the effect leading to the gaps G (cf. FIG. 2) is removed or at least reduced.

FIG. 6 depicts a side view of the anti-ballistic plate assembly 10 of FIG. 4, however without being mounted on a person. The front plate 1 has an upper and inner edge portion 1d. Correspondingly, the back plate 2 has an upper and inner edge portion 2d. As can be seen in FIG. 6, there is a clearance or gap between the upper and inner edge portions 1d, 2d, and the carrying strap 5. This is possible because there is some distance between the upper and inner edge portion 1d, 2d and the strap attachment point A1, A2.

On the front plate 1, there is a first vertical distance D1 between the upper and inner edge portion 1d and the strap attachment position A1. Correspondingly, on the back plate 2 there is a second vertical distance D2 between the upper and inner edge portion 2d and the strap attachment point A2.

Moreover, for the embodiment of the anti-ballistic plate assembly 10 shown in FIG. 6, the first vertical distance D1 of the front plate 1 is smaller than the second vertical distance D2 of the back plate 2.

Furthermore, in the shown embodiment, however also possible in other embodiments, the shape and size of the front plate 1 and the back plate 2 are identical. Consequently, when manufacturing the anti-ballistic plate assembly 10 according to the shown embodiment, one will need to produce only one type of anti-ballistic plate 1, 2. However, using different plates for the front plate 1 and the back plate 2 is possible.

Still referring to FIG. 6, it shall be noted that the strap attachment points A1, A2 relates to the upper edge or upper portion of an attachment area. As a skilled person will appreciate, to attach the carrying strap 5 to the plate 1, 2, there is advantageously an attachment strip or attachment area, and not merely a single attachment point. For instance, the attachment area may extend some centimeters downwards along the plate 1, 2 from the attachment point A1, A2.

FIG. 6a is an enlarged portion of FIG. 6, showing the upper part of the back plate 2. As illustrated with FIG. 6a, there is a free, upper end portion 11 of the back plate 2 which can form a gap 13 between the plate 2 and the carrying strap 5. The front plate 1 can have a corresponding gap 13 between the plate and the carrying strap 5.

FIG. 7 is a rear view that schematically illustrates two attachment areas 7a for the front plate 1. Two carrying straps 5 are attached to the inner face 1b of front plate 1 at respective attachment areas 7a. The first vertical distance D1 between the attachment point A1, which is the upper portion of the attachment area 7a, and the upper and inner edge portion 1d is indicated with the double-pointed arrow.

A similar illustration can be made for the back plate 2 to illustrate the vertical distance D2 between the upper and inner edge portion 2d and the attachment point A2. FIG. 8 depicts the back face 2b of a back plate 2. In this embodiment, the two attachment straps 5 that extend downwards from the shoulder of the carrying person (not shown) are joined in a carrying sheet 5a, typically a fabric. The carrying sheet 5a is attached to the back plate 2 at the attachment area 7b. The uppermost location of the attachment area 7b is defined as the attachment point A2.

As appears from FIG. 7, the attachment area 7b of the back plate 2 is substantially formed as a horizontally extending attachment. As in the shown embodiment, the attachment area 7b can be parallel to the upper and inner edge portion 2d of the back plate 2.

Advantageously, for the shown or any other embodiment of the invention, the first vertical distance D1 for the front plate 1 is between 5 and 50 mm, more preferably between 20 and 35 mm, or between 25 and 30 mm.

Advantageously, for the shown or any other embodiment of the invention, the second vertical distance D2 for the back plate 2 is between 5 and 80 mm, more preferably between 40 and 70 mm, or between 55 and 60 mm. By having the attachment point A2 (or the attachment area 7a), where the carrying strap(s) are attached to the back plate 2, at the height of the natural bend of the back, the back plate 2 is better anatomically adjusted to the shape of the carrying person 3. This effect can be appreciated by comparing the prior art solution in FIG. 2 with the inventive solution shown in FIG. 4.

Typical dimensions of an anti-ballistic plate 1, 2 used with an anti-ballistic plate assembly 10 according to the invention can be 250 mm x 300 mm (width x height). However smaller and larger plates may also be used, for instance having widths between 200 and 300 mm, and heights between 250 and 350 mm.

Typically, the anti-ballistic plate 1, 2 can be a multi-curved plate.

FIG. 9 shows an anti-ballistic plate assembly 10 in a more realistic embodiment. As can be seen in FIG. 9, the upper and inner edge 1d of the front plate 1 is arranged at some horizontal distance from the chest of the wearing person 3.

FIG. 10 is a perspective view of a worn anti-ballistic plate assembly 10.

1. An anti-ballistic plate assemblyconfigured to be worn by a person, comprising:
one or more of:
1) an anti-ballistic front plateconfigured to protect the front of a chest of the personand having an inner faceand an outer face; and
2) an anti-ballistic back plateconfigured to protect the back of a personand having an inner faceand an outer face;
further comprisingtwo carrying strapsextending over a shoulder of the person, on respective side of the person’s neck, wherein the carrying strapsare attached to the front plateor the back plate, respectively, or to the front plate and to the back plate, respectively, at respective attachment areas, wherein the attachment areasare located at the inner face;
wherein the anti-ballistic front plateor the anti-ballistic back plate, or both the anti-ballistic front plateand the anti-ballistic back plate, have an upper and inner edge portion; and
wherein the attachment areaof the front plateor back plate, or the attachment areaof both the front plateand the back plate, respectively, is arranged a respectively first and/or second vertical distance below the upper and inner edge portion.

2. The anti-ballistic plate assemblyaccording to claim 1, wherein the anti-ballistic front plateand the anti-ballistic back plateand that the first vertical distance is smaller than the second vertical distance.

3. The anti-ballistic plate assemblyaccording to claim 1, wherein the first vertical distanceis between 5 and 50 mm, more preferably between 20 and 35 mm, or between 25 and 30 mm.

4. The anti-ballistic plate assemblyaccording to claim 1, wherein the second vertical distanceis between 5 and 80 mm, more preferably between 40 and 70 mm, or between 55 and 60 mm.

5. The anti-ballistic plate assemblyaccording to claim 1, wherein one or more of the front plateand the back platehas a width between 200 and 300 mm and a height between 250 and 350 mm.

6. The anti-ballistic plate assembly according to claim 3, wherein the first vertical distance is between 20 and 35 mm.

7. The anti-ballistic plate assembly according to claim 6, wherein the first vertical distance is between 25 and 30 mm.

8. The anti-ballistic plate assembly according to claim 4, wherein the second vertical distance is between 40 and 70 mm.

9. The anti-ballistic plate assembly according to claim 8, wherein the second vertical distance is between 55 and 60 mm.
